(19) United States
(12) Patent Application Publication
(10) Pub. No.: US 2025/0259122 A1
(43) Pub. Date: Aug. 14, 2025

(54) System and Method for Project Management and Scheduling

(71) Applicants: Antwan Depaul, Corona, CA (US); Mary Depaul, Corona, CA (US)

(72) Inventors: Antwan Depaul, Corona, CA (US); Mary Depaul, Corona, CA (US)

(21) Appl. No.: 18/439,231

(22) Filed: Feb. 12, 2024

(51) Int. Cl. G06Q 10/0631

(52) U.S. Cl. CPC G06Q 10/06313; G06Q 10/063112; G06Q 10/063114; G06Q 10/063118

(57) ABSTRACT

A system and method for project management and scheduling across a communication network are provided. Namely, the system generates tasks within received project parameters and generates a timeline for the project and for each of the tasks. The system may assign each of the tasks to a vendor user having at least one qualification and transmit any of the project parameters, including the timeline, associated with the task to the vendor user. A view generator provides a project view that indicates a link between the vendor user, the task, and the timeline. Specific tasks in the project may be dependent on another of the tasks in the project, and the system may order the tasks in the timeline according to their dependencies.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to project and timeline management, and more particularly, to systems and methods for monitoring multiple users and tasks associated with or assigned to a project.

### BACKGROUND

Computer-implemented project management tools are commonly used to permit oversight of various tasks and third-parties associated with a project. Given the range of project types and their unique challenges, many proposals to accommodate the variety of tasks have been necessarily proposed.

Traditional methods of project management involve trained individuals, communicating with other similarly trained individuals to coordinate each aspect of the project. This is a labor intensive, as an individual must be in charge of coordinating each aspect of the project, often communicating with multiple parties, creating a timely and ordered schedule, ensuring access, and manually collecting and cataloging information related to different aspects of the project. The lack of integration in these traditional methods creates an environment ripe for mistakes and inefficiencies. Indeed, in many projects where certain tasks must be done in a specific order, a breakdown in communication and planning may result in additional costs or delays in the projects.

As a result, there have been numerous proposals for computer-integrated systems that alleviate some of the challenges associated with project management. Examples of these include:
U.S. Pat. No. 8,407,078 to Michele Caputo et al. for “Method of and system for managing projects, programs and portfolios throughout the project;”
U.S. Pat. No. 8,306,841 to Herman J. Clarke for an “Enterprise project management system and method therefor;”
U.S. Pat. No. 10,083,412 to Martin Suntinger et al for “Systems and method for scheduling work items.”

While each of these patents seeks to improve traditional forms of project management, none provide a system to connect multiple third parties to a centralized project hub for scheduling and management of a project.

For example, Sunitnger proposes a scheduling system that strictly schedules tasks in a linear project. This proposal may be suitable for a company's internal use where a project progressively builds on itself, however, it is not suitable for distinct, yet related, tasks in a project any of which may be dependent on any number of other tasks.

Another proposal for a schedule management system is provided in U.S. Patent Pub. No. 2012/0023454 to Pieruschka for an event scheduler for recurring events. While Pieruschka's proposal may be beneficial for generating routine schedules, it fails to provide a system for projects with varying tasks.

Currently, no solution has been proposed that provides a centralized project management system across a communication network to generate and assign a plurality of tasks within a project, or plurality of unique, but related, projects. Thus, although various proposals have been made to solve the problem, none of those in existence combine the characteristics of the present invention.

### SUMMARY

The present disclosure is directed to a system and method for project management executable by at least one processor. The system may comprise a location manager configured to cause the at least one processor to assign a project related to a unit having at least one fixture within a scheduling module, a task manager configured to cause the at least one processor to store at least one task associated with at least one filter within the scheduling module, a vendor manager configured to cause the at least one processor to store a link between any of the at least one tasks and a vendor user in a vendor directory, and a view generator configured to cause the at least one processor to provide a project view which display on a user interface the link in association with the vendor and the at least one task.

The project may be defined by at least one task related to a unit. In some embodiments then, a project may be defined by a plurality of tasks related to the same unit as one another. For example, the project may be defined by at least one task directed to turning over a particular unit, such as an apartment unit, from one tenant to another; remodeling or repairing some feature(s) or aspect(s) of the unit; or any of a task or series of tasks relating to the same unit. The project may be defined by project parameters, which may include any of a project start date, a project end date, the administrative user, or other information to define the project, including any of the at least one fixtures discussed in more detail below.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the at least one processor may be implemented by a computing system, configured to receive information corresponding with an administrative user and a vendor user. It will be understood that the at least one processor may be housed by a computing device such as a smartphone, tablet, desktop, laptop, or other computer operative to receive and transmit data defining, at least text-based messages, and text, audio, and image files, among others, of various formats known to those of ordinary skill in the art.

Of course, unlimited numbers of users and associated profiles are contemplated, however, this disclosure will focus on the administrative user and the vendor user for the sake of brevity and in the interest of clarity.

In one embodiment, a method including executing instructions stored on a computer-readable medium using at least one processor may include assigning the unit having at least one fixture within a location manager. The location manager may link the unit with a property, for example, an apartment complex, a zip code, a duplex, a single property, a hotel, an office building, or any other location that a person of ordinary skill in the art may desire.

Each of the at least one fixtures may be associated with or characterize the unit. For example, the at least one fixture may comprise, appliances, cabinetry, window coverings, flooring, or any other fixture that may be needed or desired. Further, the unit may be characterized by at least one feature, including for example and without limitation any of a room type and number, layout, and square footage. Of course, other fixtures or features, such as electrical, plumbing, or chattel affixed to the property may be associated with or characterize the unit and may be collectively referred to as the at least one fixture in this disclosure for the sake of simplicity.

In some embodiments, the system may suggest fixtures according to another of the at least one fixture. In other words, the system may be operative to generate or even prompt a user to assign one or more fixtures to the unit according to the types of fixtures and/or features characterizing the unit. For instance, in one exemplary embodiment, the system may suggest associating certain fixtures to a unit according to those fixtures and/or features associated with or otherwise characterizing other units in the location manager. Of course, the system may be further operative to receive any of the at least one fixtures from the administrative user.

The system may receive a first status for any of the at least one fixtures associated with the project. The first status for each of at least one task may indicate that the at least one fixture requires cleaning, repair, or replacement. The task manager may sort each of the at least one fixtures through the at least one filter according to the first status to generate at least one task associated with the project.

The scheduling module may assign a timeline to the project. More particularly, the scheduling module may assign a due date to each of the at least one tasks to define the timeline. The timeline may, in some embodiments, further comprise a start date for each of the at least one tasks in the project. It is contemplated that any due date and/or start date of the at least one task may be dependent on another due date and/or start date of the at least one task. The scheduling module may be operative to update the due date, or even the start date, for any of the at least one tasks according to an update received to another of the at least one tasks in the project. In some embodiments, the scheduling module may update the due date of at least one task according to a change in due date of another of the at least one tasks.

In one embodiment, the timeline may be updated by any user in the system. For example, the administrative user may advance the due date of the at least one task. In some embodiments, the administrative user and/or vendor user may assign the due date and/or start date to any of the at least one tasks. In a further embodiment, the administrative user and/or vendor user may assign any of the at least one tasks to be dependent on another of the at least one task.

The system may be configured to generate the vendor directory comprising at least one vendor user, each comprising at least one qualification. The at least one qualification may be an invitation, a skill associated with the task, an availability, a proximity to the unit, or any other qualification or combination of qualifications that may be desired. A person of ordinary skill in the art will recognize that the aforementioned qualifications are provided for example only and any desired qualification may be utilized.

The at least one processor may store a link between any of the at least one tasks and the vendor user comprising a desired qualification. The link may be an assignment of the task to the vendor user and may, in some embodiments, comprise linking the task to a vendor calendar.

The at least one processor may provide the project view that indicates the link in association between the vendor user and the at least one task. The project view may further indicate the timeline of the unit, including the due date for each of the at least one tasks. In some embodiments, the project view may comprise a calendar that displays any of the timeline. However, in other embodiments, the project view may be a list or any other display that may be desired.

Several advantages of the system and method are that they:
(a) create a centralized hub for tasks and communications within a project;
(b) assign due dates to each of the at least one tasks to optimize
(c) generate timelines by ordering the due dates of any of the at least one tasks; and
(d) create a directory of locations, units, and vendors easily accessible for reference.

Thus, it is an object of this invention to improve efficiency in managing projects and timelines, reducing wasted time during the project.

It is another object of this invention to generate a dynamic timeline that coordinates various start and due dates of tasks assigned to third-parties.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is unblocked diagram of a networked environment in which an exemplary embodiment of a system for project management and scheduling is implemented.

FIG. 2 shows an exemplary embodiment of a computing device in FIG. 1.

FIG. 3 shows an exemplary embodiment of a system for project management and scheduling in FIG. 2.

FIG. 4 shows a method for project management and scheduling.

FIG. 5 shows an exemplary user interface for a location manager.

FIG. 6 shows an exemplary user interface for receiving information to define a project.

FIG. 7 shows an exemplary user interface for the task manager.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

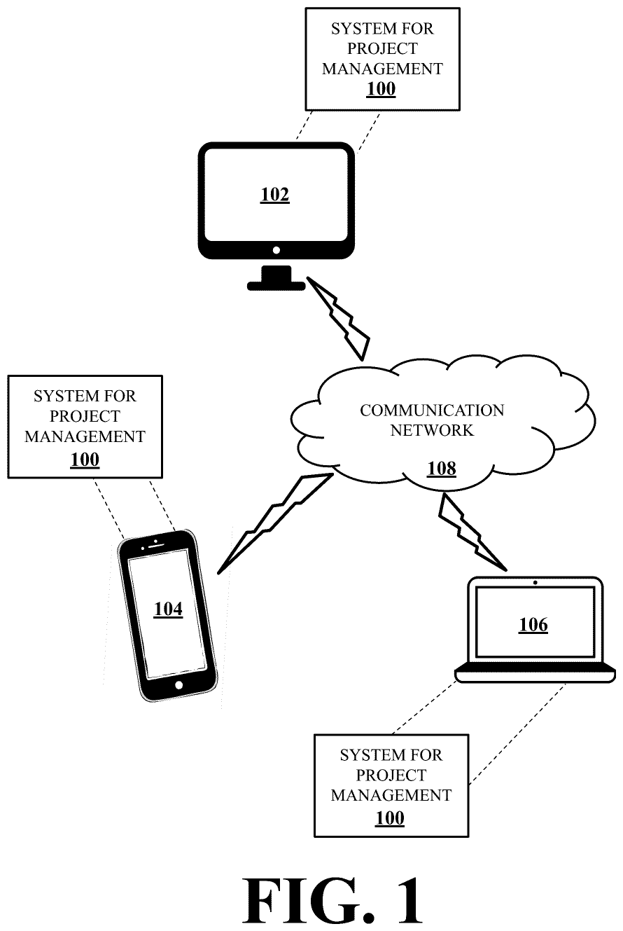

A description of an embodiment of a system and method for project management across at least one computing device is now described followed by a discussion of the operations of various components within the system. In this regard, FIG. 1 illustrates, in a block diagram, an exemplary embodiment of the system 100 for project management which includes at least one computing device 102, 104, and 106 coupled together via a communication network 108. By way of example and not limitation, FIG. 1 illustrates three computing devices 102, 104, and 106. Of course, any number of computing devices is contemplated. Each of the computing devices may be embodied as a personal computer, tablet computer, laptop computer, smartphone, or any other computing device known in the art. Notably, the communication network 108 can use one or more various communication types such as, for example, and without limitation, cellular and Wi-Fi communications.

Users of the computing devices 102, 104, and 106 may be any user who may have access the system. For example, the user of computing device 102 may be an administrative user and the user of computing devices 104 and 106 may be at least one vendor user. The communication network 108 enables users to use their computing devices 102, 104, and 106 to interact with the system 100 for project management. Notably, the communication network 108 may enable users to use their computing devices 102, 104, and 106 to interact with each other.

The users of any of the at least one computing devices 102, 104, and 106 may use their devices to access the system 100 for project management. In one embodiment, the administrative user may access the system 100 on a first computing device 102, and the at least one vendor user may access the system 100 on a second computing device 104 or third computing device 106. More particularly, each of the at least one vendor users may access the system 100 on any of the second computing device 104 or third computing device 106.

A person of ordinary skill will recognize that any user, for example, viewing, auditing, or third-party users, may access the system 100. Further, the system is not limited to three users or computing devices, but may be any number of users or computing devices.

In this regard, the system 100 for project management includes various modules, which can be implemented in numerous ways, such as, for example, and without limitation, a downloadable applications, web-based application, website, or the like. For example, the system 100 may receive user information to uniquely identify users in the communication network 108 (in this case, users of computing devices 102, 104, and 106). Additionally, the system 100 receives information corresponding to any information supplied by each user, project parameters, contributions, requests, and other information.

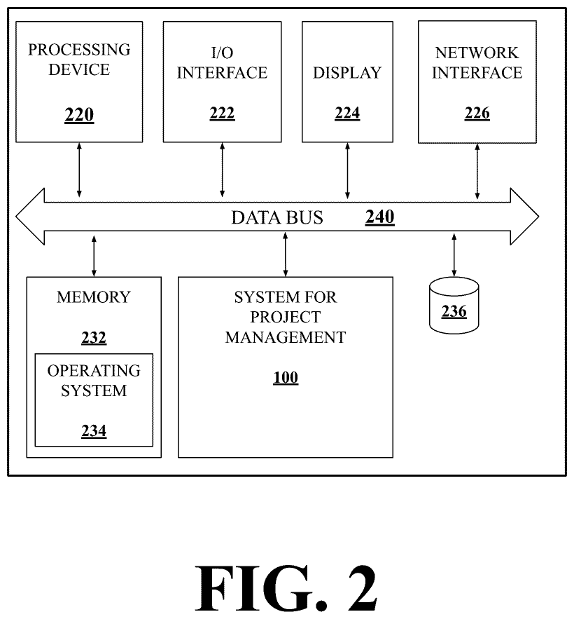

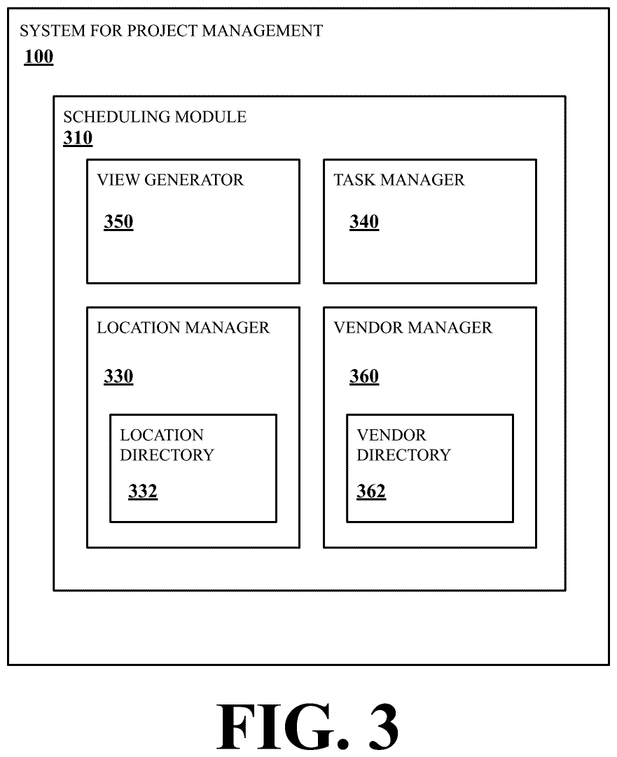

FIG. 2 illustrates an exemplary embodiment of any of the computing devices 102, 104, and 106 shown in FIG. 1. For the purpose of clarity, FIG. 2 will be discussed with reference to computing device 102, however, any computing device may be utilized. As described, computing device 102 may be a tablet computer, personal computer, laptop computer, or smartphone, but may also be embodied in any of a wide variety of wired and/or wireless computing devices. As shown in FIG. 2, computing device 102 includes a processing device processor 220, input/output interfaces 222, a display 224, a network interface 226, a memory 232, an operating system 234, and a mass storage 236 with each communicating across a local data bus 240. In some embodiments, the computing device may further include a touchscreen interface, an audio interface, and even a GPS (not pictured). Additionally, as shown in FIG. 2, computing device 102 incorporates a system 100 for project management, which is discussed in more detail with reference to FIG. 3.

Returning to FIG. 2 the processing device 220 may include any custom-made or commercially available processor, a central processing unit (CPU), or an auxiliary processor among several processors associated with the computing device 102, a semiconductor-based microprocessor (in the form of a microchip), a macro processor, one or more application specific integrated circuits (ASICs), a plurality of suitably configured digital logic gates, and other electrical configurations comprising discrete elements both individually and in various combinations to coordinate the overall operation of the system.

The memory 232 can include any of a combination of volatile memory elements (e.g., random-access memory (RAM, such as DRAM, and SRAM, etc.)) and nonvolatile memory elements. The memory typically comprises native operating systems 234, one or more native applications, emulation systems, or emulated applications for any of a variety of operating systems and/or emulated hardware platforms, emulating operating systems, etc. For example, the applications may include application-specific software, which may comprise any or all the components of the computing device 102. In accordance with such embodiments, the components are stored in memory and executed by the processing device. Note that although depicted separately in FIG. 2, the system for project management may be resident in memory, such as memory 232.

One of ordinary skill in the art will appreciate that the memory 232 can, and typically will, comprise other components which have been omitted for purposes of brevity. Not that in the context of this disclosure, a non-transitory computer-readable medium stores one or more programs for use by or in connection with an instruction execution system, apparatus, or device. With further reference to FIG. 2, the network interface device 226 comprises various components used to transmit and/or receive data over a networked environment, such as depicted in FIG. 1. When such components are embodied as an application, the one or more components may be stored on a non-transitory computer-readable medium and executed by the processing device.

FIG. 3 shows a detailed embodiment of the system 100 for project management, as shown in FIG. 2. The system 100 for project management comprises a scheduling module 310, a location manager 330, a task manager 340, a view generator 350, and a vendor manager 360. Each module comprises certain information and data or is configured to receive and execute instructions related to certain information and data, or is configured to receive and execute instructions related to certain information and data.

The location manager 330 may comprise a location directory 332. The location directory 332 may comprise at least one unit having at least one fixture. In some embodiments, the location directory 332 may further comprise at least one feature characterizing the unit. For example, and without limitation, the at least one feature may comprise the number and/or type of rooms and location of the property, and the at least one fixture may comprise any of the appliances, flooring, lighting, or cabinetry.

The location manager 330 may be operative to link any of the at least one units to another of the at least one units to correspond a property. It is contemplated that the property may be less than fully represented in the location manager 330. Instead, as a person of ordinary skill will recognize that with time, the property may be more fully represented by the at least one unit as additional units and/or fixtures corresponding linked to the property by the location manager 330.

The location manager 330 may further link any of the at least one units to the administrative user and/or the vendor user. It is contemplated that the location directory 332 may comprise each of the at least one units linked to the user. As such, the location directory 332 may be unique to each user in the system. For example, the administrative user may be associated with each of the at least one units in the property. Of course, the administrative user may be associated with multiple properties in the database or less than all of the at least one units in the properties. The task will be discussed in more detail below. As the vendor user may be linked to multiple tasks from different administrative users, the vendor and the administrative users may each comprise a unique location directory 332.

It is contemplated that the system may be able to receive any of the at least one fixtures from the administrative user. It still a further embodiment, the system may be able to receive any of the at least one fixtures from the vendor user. Of course, any of the at least one fixtures may come from any source that may be desired.

In some embodiments, any of the at least one fixtures information may be generated from another of the at least one units. It is contemplated that this may occur when the unit shares a common fixture with another unit in the location directory. For example, the common fixture may be square footage, building letter/number, rooms, or any other fixture that a person in the art may recognize. Further, the user may manually relate the unit to another unit to generate the at least one fixture.

Any of the at least one fixtures may comprise a status of the fixture. The status may correspond to whether the fixture is in an acceptable condition, needs attention, or needs replacement. The status may be used to identify any of the at least one fixtures to be assigned, as discussed in more detail throughout.

Indeed, the task manager 340 may be operative to filter each of the at least one fixtures according to its status. The task manager 340 may assign a task to each of the at least one fixtures comprising the status is below a threshold. For example, any of the at least one fixtures whose status indicates the fixture needs attention or replacement may be assigned as a task. Each task, collectively referred to as at least one task, may be given a label indicating work needed to be done within a project.

In some embodiments, there may be any number of pre-set tasks that occur for each unit. This may be coordinated with any of the tasks in the task manager 340 and may automatically be assigned to the unit. As multiple tasks are assigned using the task manager 340 may be configured to establish, maintain, or implement relationships between the at least one task and any of the vendors in the vendor directory 362.

The task manager 340 may update each of the at least one tasks according to information received from the users in the system. It is contemplated that scheduling module 310 may update any of the timelines associated with the project.

The view generator 350 may be operative to display any of the information stored in the scheduling module 320 at the at least one computing device. More particularly, the view generator 350 is configured to display the link between any of the location manager 330, vendor manager 360, and task manager 340.

In some embodiments, the view generator 350 may be further operative to display ancillary information relating to the unit. The ancillary information may comprise, for example, invoices, order numbers, part numbers, pictures, comments, or any other information that a person of ordinary skill may desire.

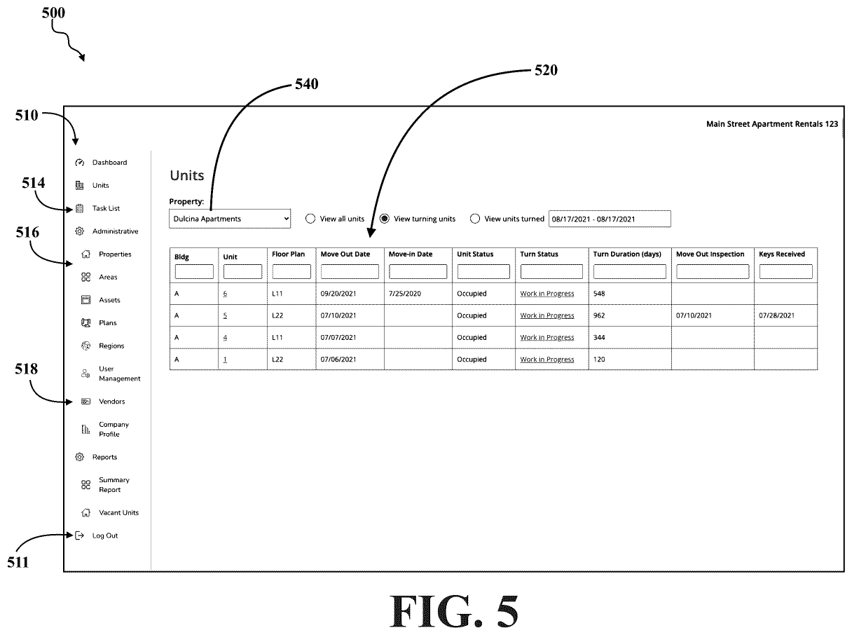

The view generator 350 is discussed in more detail with reference to exemplary user interfaces in FIGS. 5-7 with examples of exemplary user interfaces.

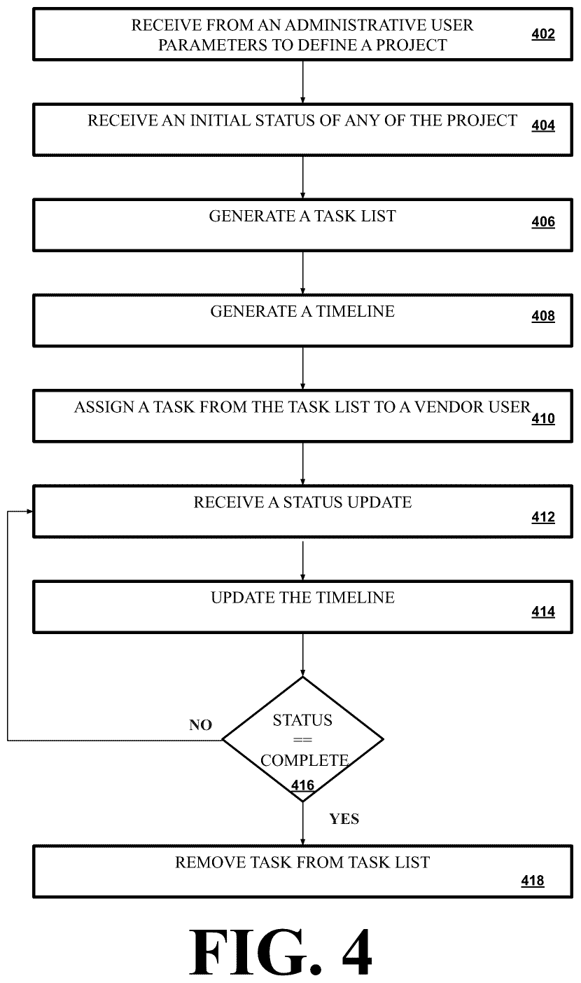

FIG. 4 illustrates an exemplary method 400 for project management carried out by the system. The method includes the steps of: receiving parameters from an administrative user to define a project 402; receiving an initial status of any of the project 404; generating a task list 406; generating a timeline 408; assigning a task from the task list to a vendor user 410; receiving a status update 412; updating the timeline 414; and responsive to the status being complete 416 removing the task from the task list 418.

The parameters to define the project may comprise all or part of a location, a unit, square footage associated with the unit, a start date, and a desired end date. The parameters to define the project may further comprise at least one fixture associated with the unit. The at least one fixture may be at least partially informed by another of the parameters. The parameters may further comprise whether the unit is vacant, potential hazards, budget, scheduling. Of course, other parameters may be utilized to define the project, and the aforementioned are provided as non-limiting examples.

The initial status received by the system (step 404) may correspond with the status of any of the at least one fixtures when the project is defined. Of course, the initial status may be received at a later time and may define the status at the start of the project. In some embodiments, the initial status may be a selection from a list of set statuses, a numerical grade, or sliding scale. Of course, any manner of receiving the initial status is contemplated.

The task list may comprise at least one task associated with the project. Any of the at least one tasks may be associated with any of the at least one fixtures comprising the initial status below a predetermined threshold. The predetermined threshold may be a filter operative to identify which, if any, of the at least one fixture requires attention. For example, the task may be to replace or repair any of an appliance, flooring, doors, window coverings, electrical, or any other fixture that may be desired. A person of ordinary skill will recognize the variety of fixtures that may be present in the unit and the task may relate to the task.

In some embodiments, the administrative user may be operative to assign any of the at least one tasks to the task list regardless of the initial status of the at least one fixture. Further, in some embodiments, any of the at least one tasks may be a standard task assigned to each project. For example, the standard task may comprise any of cleaning, inspection, listing, changing of locks, or any other task that may be desired.

The system may be operative to assign a due date to each of the at least one tasks to generate the timeline 408. Any of the at least one tasks may be dependent on another of the at least one task and may be assigned to the timeline accordingly. For example, in some instances, replacing and/or repairing flooring may be dependent on painting, and the system may assign a due date to painting before a start date to flooring. Of course, the tasks may be ordered in any manner that may be desired.

In some embodiments, any of the at least one tasks may be an independent task wherein the due date is not dependent on another of the at least tasks. Further, the administrative and/or vendor user may change the due dates of any of the at least one tasks.

The system may be operative to assign any of the tasks from the task list to the vendor user 410. As discussed with reference to FIG. 3, the vendor may be any vendor user in the vendor directory 362. More particularly, the vendor user may be any vendor user in the vendor directory 362 that comprises at least one qualification desired for the assigned task. The at least one qualification may, for example, be any of an invitation to the system associated with the unit, a skill characterized by the task manager, an availability correlating with the timeline module, and a proximity characterized by the location manager. Of course, any desired qualification may be utilized and the aforementioned are provided as non-limiting examples.

The system may be operative to assign the task from task list to the vendor user 410 according to any of the at least one qualifications of the vendor user. In some embodiments, the computing device associated with the administrative user may transmit a request to the computing device associated with the vendor user in the form of an invitation to the task. In another embodiment, any of the vendors in the vendor directory may transmit a request for any of the at least one tasks to the administrative user. It is contemplated that the request and/or invitation may, in some embodiments, correspond to the at least one qualification.

Assigning any of the at least one tasks from the vendor user may, in some embodiments, transmit any of the timeline relevant to the at least one task to the vendor user. Indeed, each vendor user may comprise a vendor timeline that comprises any of the timeline relevant to the at least one task.

Returning to the method in FIG. 4, the step of assigning the task from the task list to the vendor user 410 may be repeated for each of the at least one tasks associated with the project. In some embodiments, any of the at least one tasks may be assigned internally, such as to the administrative user. In another embodiment, multiple of the at least one task may be assigned to the same vendor user.

The system may be operative to receive a status update 412 from any of the administrative user, the vendor user, or even the third party user. The status update may be any update related to the at least one task that a person of ordinary skill may desire. For example, the status update may be the completion of the task or a task that the task is dependent on. As another example, the status update may be any of an work order, purchase order, delay, or any other status update that may be desired.

The system may be operative to update the timeline 414 according the received status update (step 412). A person of ordinary skill will recognize that

It is contemplated that any of the due dates assigned to any of the at least one tasks may be updated. In some instances, the status update may indicate a delay in the project and any of the due dates in the timeline may be changed accordingly. In some embodiments, the start date of any of the at least one tasks may be updated. Of course, the update to the timeline may be that the at least one task is projected on time and no start or due dates may be updated.

Updating the timeline may comprise updating the timeline associated with the project. Further, updating the timeline may comprise updating the vendor timeline.

Responsive to the status being updated to complete (416), the task may be removed from the task list 418. This may involve, in some involvement, removing the task from appearing on the task list. However, in other embodiments, the task may appear on the task list but the system may remove the task from any tasks to be completed on the task list. It is contemplated that any manner of removing the task from the task list may be utilized.

It should be understood that the method is described for one task, however, steps 410-418 may occur for each of the at least one tasks in the task list.

FIG. 5 illustrates an exemplary, non-limiting embodiment of a user interface 500 for the location manager module. Namely, the system may comprise a computer system implemented by a processor configured to receive location information from the user. It is contemplated that the user may be the administrative user. Of course, any of the users may be any of the users in the system, including the vendor user or the third-party user.

The system may, at a graphical user interface, prompt the user to provide any of a unit's identifying information 520 including, for example, a PROPERTY 540, BLDG (building), UNIT, FLOOR PLAN, MOVE OUT DATE, MOVE-IN DATE, UNIT STATUS, TURN STATUS, TURN DURATION (DAYS), MOVE OUT INSPECTION, and KEYS RECEIVED to identify the project. Of course, one skilled in the art will recognize other forms of identifying information 520 may be prompted. Any user responses to the prompts may be carried out by the user and received through various clickable elements and/or text boxes on the graphical user interface.

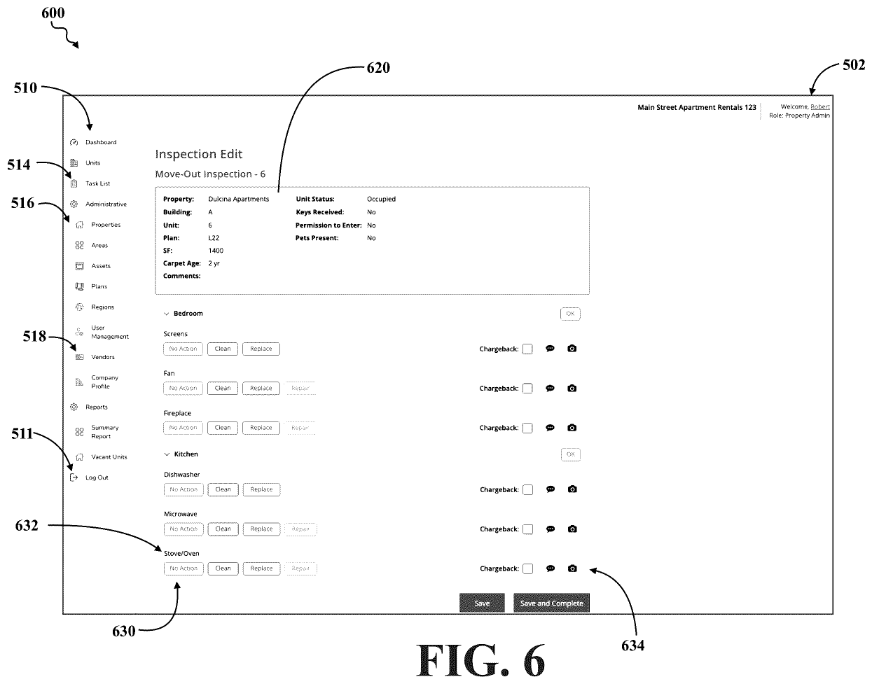

The unit's identifying information 520 may define the project and may inform any of the project parameters. Further, receiving the identifying information 520 may be operative to display a new interface. For example, receiving the identifying information 520 may generate the user interface discussed in reference to FIG. 6.

FIG. 5 further illustrates an exemplary navigation bar 510 operative to navigate throughout the system. The navigation bar 510 may be displayed in each of the system's interfaces. In the exemplary embodiment of the navigation bar 510 shown, the navigation bar 510 may comprise at least one shortcut related to any of the modules discussed in FIG. 3. As shown in FIG. 5, multiple of the at least one shortcuts may relate to the same module. For example, a shortcut 516 for the location manager, such as PROPERTIES, AREAS, ASSETS, PLANS, and REGIONS.

Of course, other shortcuts may be displayed and may relate to one of the modules. For example, VENDORS 520 may relate to the vendor directory 362 illustrated in FIG. 3, USER MANAGEMENT 518 may relate to the vendor manager 360. Further, UNITS 512 may relate to the location directory 332, and TASK LIST 514 may relate to the task manager 340.

It should be recognized that any of the shortcuts illustrated in FIG. 5 may be any shortcut desired to operate the system, including those not discussed within the system, such as LOG OUT 511. A person of ordinary skill in the art will recognize a variety of different shortcuts that may be utilized by the system, including those not shown.

FIG. 6 illustrates an exemplary, non-limiting embodiment of a user interface 600 for generating the project associated with the unit. Namely, the system may comprise a computer system implemented by processors configured to receive the initial status from the user. It is contemplated that the user 502 may be any of the administrative user, vendor user, or third-party user. Reference is made throughout to the user 502 being the administrative user.

The system may, at a graphical user interface generated by the view generator, display any of the unit's identifying information 620. One manner in which the system may receive the project parameters is discussed with reference to the graphical user interface displayed in FIG. 6.

The system may prompt the user to provide a first status 630 of any of the at least one fixtures 632 associated with the unit. In this example, each of the at least one fixtures 632 is sorted according to a feature of the unit, for example the room (here, BEDROOM and KITCHEN) in which the fixture is located.

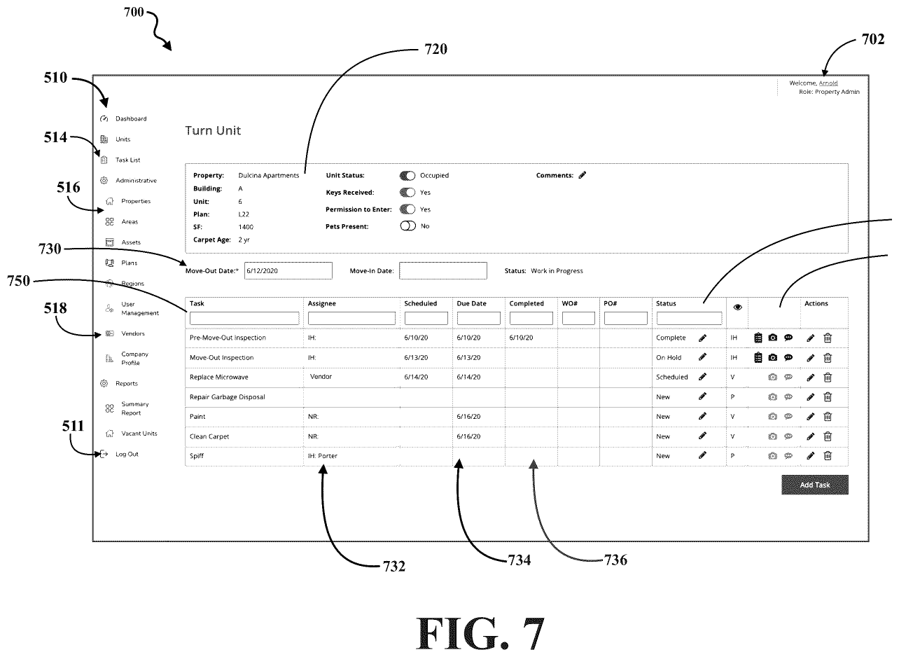

It is contemplated that the user may select the first status 630 for any of the at least one fixtures. The first status 630 may be displayed as clickable prompts. For example, the clickable prompts may be “No Action,” “Clean,” “Replace,” and, in some instances, “Repair.” Any of the clickable prompts may be selected for each of the at least one fixtures 632. Selection of the clickable prompts may, in some instances, generate any of the at least one tasks, discussed in more detail with reference to FIG. 7. Of course, other methods of receiving the status are contemplated, and the clickable prompts are provided as non-limiting examples.

Returning to the user interface illustrated in FIG. 6, the system may permit the user to upload ancillary information 634 to any of the at least one tasks 632. As shown the ancillary information 634 may comprise any of a comment, picture, or chargeback. Of course, one skilled in the art will recognize other forms of ancillary information 634 that may be prompted.

It is contemplated that the identifying information 520 received in the user interface discussed in FIG. 5 and the status information discussed in FIG. 6 may define the project. However, the graphical user interface may further prompt the user to input additional information. The additional information may be dependent on any of the information inputted and may, for example, be additional fixtures, details, timeframes, cost estimates, or even vendor qualifications. Of course, other additional information may be prompted, and the aforementioned are provided as non-limiting examples.

FIG. 7 illustrates one exemplary embodiment of an interface 700 for one project in the task manager. It is contemplated that the task manager module may provide a centralized hub specific to the task. The centralized hub may allow at least one user 702 associated with the project to access the project. As shown, the interface is that of the administrative user and the interface may vary for each of the users who have access.

The interface 700 may, for example, display any of the unit's identifying information 720, a timeline, a vendor user assigned to the task (here, ASSIGNEE 760), each of the at least one tasks in the task list 750 (here, TASK), and any ancillary information that may be desired.

The timeline may comprise a MOVE-OUT DATE 730, a SCHEDULED 732 date, a DUE DATE 734, and a COMPLETED 736 date. Any of the timeline dates may be received from the user 702 and may be used to generate another of the timeline dates. For example, a PRE-MOVE-OUT INSPECTION may occur prior to the MOVE-OUT DATE 730 and a MOVE-OUT INSPECTION may occur after the MOVE-OUT DATE 730. Any of the other tasks on the task list 750 may comprise a DUE DATE 734 after the MOVE-OUT DATE 730.

The system may be further operative to receive a MOVE-IN DATE 738 from the user 702. The MOVE-IN DATE 738 may be a due date for the project in its entirety. It is contemplated that the MOVE-IN DATE 738 may be added after any of the at least one tasks are completed. Indeed, in some instances, all of the at least one task may be completed prior to the MOVE-IN DATE 738 being received.

A status 770 of each task in the task list 750 is shown in line with the individual task. The status 770 may be the status received in FIG. 6. As shown, in FIG. 7, the status 770 may comprise a clickable element that permits the status 770 to be updated.

Each vendor 760 assigned to each task in the task list 750 may be shown in line with the task. Here, “IH” may be an abbreviation for “In House” and indicate that the vendor may be assigned to a vendor user associated with the property and/or the administrative user. “NR” may be an abbreviation for “Needs Referral” and may indicate that the vendor has yet to be assigned to the task. In some embodiments, the referral may be one of the qualifications associated with the vendor user. As shown, REPLACE MICROWAVE is assigned to VENDOR, which may be any vendor in the vendor directory with a qualification.

Any of the ancillary information 634 received at the interface in FIG. 6 may be available under an ancillary information 780 column in the interface shown in FIG. 7. A person of ordinary skill will recognize that other prompts are displayed, and information relevant to the prompt may be received by the system, including WO #(work order) and PO #(purchase order), that may be well known in the art. These may be utilized to track any of the aspects of the project, including costs and payments, that may be external to the system. Of course, any of these may be internal, and the system may be configured with work and purchase order payment module.

### CONCLUSIONS, RAMIFICATIONS, AND SCOPE

While certain embodiments of the invention have been illustrated and described, various modifications are contemplated and can be made without departing from the spirit and scope of the invention. For example, the system may be utilized with various types of project management. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method for project management and scheduling with which that terminology is associated. In general, the terms used in the following claims should not be constructed to limit the system and method for project management and scheduling to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system and method for project management and scheduling is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system and method of project management and scheduling.

What is claimed is:

1. A system comprising instructions stored on a non-transitory computer readable medium and executable by at least one processor, the system comprising:
a location manager configured to cause the at least one processor to assign a unit having at least one fixture within a scheduling module comprising a timeline associated with the unit;
a task manager configured to cause the at least one processor store at least one task associated with at least one fixture within the scheduling module;
a vendor manager configured to cause the at least one processor to store a link between the any of the at least one tasks and a vendor in a vendor directory;
a view generator configured to cause the at least one processor to provide a project view which indicates the link in association with each vendor to the at least one fixture.

2. The system of claim 1, wherein the project view displays the timeline in the scheduling module, and each of the at least one tasks is assigned a start date and an end date.

3. The system of claim 1, wherein each vendor in the vendor directory comprises at least one qualification.

4. The system of claim 3, wherein the at least one qualification is any of an invitation to the system associated with the unit, a skill characterized by the task manager, an availability correlating with the timeline module, and a proximity characterized by the location manager.

5. The system of claim 1, further operative to receive ancillary information and link the ancillary information to the project.

6. The system of claim 1, wherein the location manager comprises a location directory.

7. The system of claim 6, wherein the location directory comprises a plurality of properties each comprising at least one unit.

8. The system of claim 1, wherein any of the at least one task may be dependent on another of the at least one task and the scheduling module is operative to assign due dates to each of the at least one tasks according to its dependency.

9. The system of claim 1, wherein the system is further operative to filter the at least one fixture through a filter to define the at least one task.

10. A method of managing projects, comprising:
on a first electronic computing device associated with an administrative user:
receiving parameters to define with a project, wherein the parameters comprises any of a property, a unit, a start date, a desired end date, and at least one fixture;
receiving an initial status of the at least one fixture associated with the unit;
generating a task list comprising at least one task associated with the project wherein each of the at least one tasks is associated with any of the at least fixtures being at or below a predetermined threshold;
generating a timeline to the project based on any of the parameters and the task list, wherein the timeline comprises a due date for each of the at least one tasks;
transmitting a request associated with at least one task to at least one secondary electronic computing device associated with a vendor user having at least one desired credential;
responsive to receiving an acceptance from the user having at least one desired credential, assigning the at least one task to the vendor associated with the secondary electronic computing device;
responsive to receiving a status update from the vendor user associated with the secondary electronic device updating the timeline; and
responsive to receiving a completed status for the task assigned to the vendor user, removing the task from the task list;
on at least one second electronic device associated with the vendor user comprising at least one credential:
receiving the request associated with at least one task from the first electronic computing device;
transmitting the response to the request to the first electronic device;
responsive to the request being acceptance, retrieving any of the parameters associated with the request from the first electronic computing device;
receiving the status update; and
transmitting the status update to the user.

11. The method of claim 10, wherein the request comprises a status of any of the at least one fixtures, the property, the initial status of the at least one fixture, and the due date associated with the at least one task

12. The method of claim 10, wherein the timeline comprises an ordered itinerary of each of the at least one tasks.

13. The method of claim 10, wherein the at least one credential is any of an invitation to the system associated with the unit, a skill, an availability correlating with the timeline, and a proximity to the property.

14. The method of claim 11, wherein accepting the at least one task may generate a vendor calendar comprising the at least one task on the at least one second computing device.
